(19) United States
(12) Patent Application Publication
(10) Pub. No.: US 2009/0225669 A1
(43) Pub. Date: Sep. 10, 2009

(54) SYSTEM AND METHOD FOR WIRELESS COMMUNICATION NETWORK HAVING ROUND TRIP TIME TEST

(75) Inventors: Xiangping Qin, San Jose, CA (US); Huai-Rong Shao, San Jose, CA (US); Harkirat Singh, Santa Clara, CA (US); Chiu Ngo, San Francisco, CA (US)

Correspondence Address: KNOBBE, MARTENS, OLSON, & BEAR, LLP, 2040 MAIN STREET, FOURTEENTH FLOOR, IRVINE, CA, 92614, US

(73) Assignee: Samsung Electronics Co., Ltd., Suwon City (KR)

(21) Appl. No.: 12/044,712

(22) Filed: Mar. 7, 2008

(51) Int. Cl. H04L 12/26

(52) U.S. Cl. 370/249

(57) ABSTRACT

A system and method for providing a proximity control between devices in a wireless network is disclosed. A test message for a Round Trip Time (RTT) test is transmitted from a first device to a second device via a modified reservation function, wherein the modified reservation function is based on a distributed media access control scheme. A response message for the RTT test is received from the second device via the modified reservation function. A distance between the first device and the second device is computed based on a round trip time delay between the test message and the response message.

### BACKGROUND OF THE INVENTION

1. Field of the Invention

The present invention relates to wireless transmission in a wireless network, and in particular, to content protection for wirelessly transmitted video data based on proximity control.

2. Description of the Related Art

For copyrighted content transmission via wireless media, the content provider is typically subject to proximity control requirements so that the wirelessly transmitted content, e.g., video or music, is used within a limited range of area. An essential element to any proximity control scheme is the measurement of distance between two devices, e.g., a Source and a Destination. A Round Trip Time (RTT) test is one method used to measure the Source-to-Destination distance. Round trip time is the duration measured from when a message is transmitted by a Source until when a response from a Destination is received by the Source. Only when the RTT test is passed, authorization keys are exchanged and the content is transmitted between the devices. For example, in the Digital Transmission Content Protection (DTCP) protocol, which is widely used for point-to-point communication (e.g., between a DVD player and a digital television), the RTT needs to be less than 7 ms.

Certain existing proximity control protocols, such as the DTCP, are designed for point-to-point wired communication. In a point-to-point wired communication, the two communicating devices are largely free from interferences from other devices. However, for wireless communication networks, e.g., a WLAN, where multiple users are accessing the same medium, interferences from other devices in the network are commonplace; and, consequently, the RTT test between Source and Destination may fail because of random access delays caused by the interferences from other devices. The resulting retransmissions introduce delays, and in some instances, devices within an allowed proximity can be falsely refused. Accordingly, proximity control schemes that are designed for use in wireless communication networks are desirable.

### SUMMARY OF THE INVENTION

The system, method, and devices of the invention each have several aspects, no single one of which is solely responsible for its desirable attributes. Without limiting the scope of this invention as expressed by the claims which follow, its more prominent features will now be discussed briefly.

In one embodiment, there is a method of providing a proximity control between devices in a wireless network, the method comprising transmitting a test message for a round trip time (RTT) test to a second device by a first device via a modified reservation function, wherein the modified reservation function is based on a distributed media access control scheme; receiving a response message for the RTT test from the second device via the modified reservation function; and computing a distance between the first device and the second device based at least partly on a round trip time delay between the test message and the response message.

In another embodiment, there is a system for providing a proximity control between devices in a wireless network, the system comprising a transmitter configured to transmit a test message for a Round Trip Time (RTT) test to a second device by a first device via a modified reservation function, wherein the modified reservation function is modified from a standard reservation function based on a distributed media access control scheme to utilize the RTT test; a receiver configured to receive a response message for the RTT test from the second device via the modified reservation function; and a processor configured to compute a distance between the first device and the second device based at least partly on a round trip time delay between the test message and the response message.

In another embodiment, there is a method of providing a proximity control between devices in a wireless network, the method comprising transmitting a test message for a Round Trip Time (RTT) test to a second device by a first device via a modified reservation function, wherein the modified reservation function is based on a polling-based centralized media access control scheme; receiving a response message for the RTT test from the second device via the modified reservation function; and computing a distance between the first device and the second device based at least partly on a round trip time delay between the test message and the response message.

In another embodiment, there is a system for providing a proximity control between devices in a wireless network for transmitting uncompressed video data, the system comprising a transmitter configured to transmit a test message for a Round Trip Time (RTT) test to a second device by a first device via a modified reservation function, wherein the modified reservation function is modified from a standard reservation function based on a centralized media access control scheme to utilize the RTT test; a receiver configured to receive a response message for the RTT test from the second device via the modified reservation function; and a processor configured to compute a distance between the first device and the second device based at least partly on a round trip time delay between the test message and the response message.

In another embodiment, there is a computer-usable medium in a system for providing a proximity control between devices in a wireless network having computer readable code comprising instructions for modifying a reservation function so as to support a Round (RTT) test between a first device and a second device in a wireless network, and computing a distance between the first device and the second device based at least partly on a round trip time delay between a RTT test message and a RTT response message transmitted and received via the modified reservation function.

### BRIEF DESCRIPTION OF THE DRAWINGS

FIG. 1 is a block diagram illustrating an example wireless local area network (WLAN) configuration using an access point.

FIG. 2 is a functional block diagram of an example wireless local area network (WLAN) system, according to one embodiment of the system and method.

FIG. 3A is a timing diagram illustrating an example of a Round Trip Time (RTT) test procedure between a Source and a Destination.

FIG. 3B is a flow diagram illustrating an example process for conducting a RTT test for proximity control using a reservation function in a WLAN according to certain embodiments.

FIG. 4 is a flow diagram illustrating an example process for preparing the DCF function of IEEE 802.11 for a RTT test according to certain embodiments.

FIG. 5 is a timing diagram illustrating an example of the existing distributed coordinated function (DCF) defined within IEEE 802.11.

FIG. 6 is a timing diagram illustrating an example of RTT test support for the DCF function according to certain embodiments.

FIG. 7 is a timing diagram illustrating another example of RTT test support for the DCF function according to certain embodiments.

FIG. 8 is a flow diagram illustrating an example process for preparing the point coordinated function (PCF) of IEEE 802.11 for RTT test according to certain embodiments.

FIG. 9 is a timing diagram illustrating an example of the existing point coordinated function (PCF) defined within the IEEE 802.11.

FIG. 10 is a timing diagram illustrating an example of RTT test support for the PCF function according to certain embodiments.

FIG. 11 is a timing diagram illustrating another example of RTT test support for the PCF function according to certain embodiments.

### DETAILED DESCRIPTION OF CERTAIN INVENTIVE EMBODIMENTS

Certain embodiments provide a method and system for proximity control in a wireless communications network.

The following detailed description is directed to certain sample embodiments of the invention. However, the invention can be embodied in a multitude of different ways as defined and covered by the claims. In this description, reference is made to the drawings wherein like parts are designated with like numerals throughout.

Embodiments include systems and methods of proximity control of transmission of copyright protected audio/video (A/V) contents in a wireless communications network will be described. In particular, certain embodiments representing proximity control schemes based on a Round Trip Time (RTT) test at the media access control (MAC) layer based on wireless protocols, e.g., IEEE 802.11, will be described. Also certain embodiments representing other proximity control schemes based on an authorization token will be described.

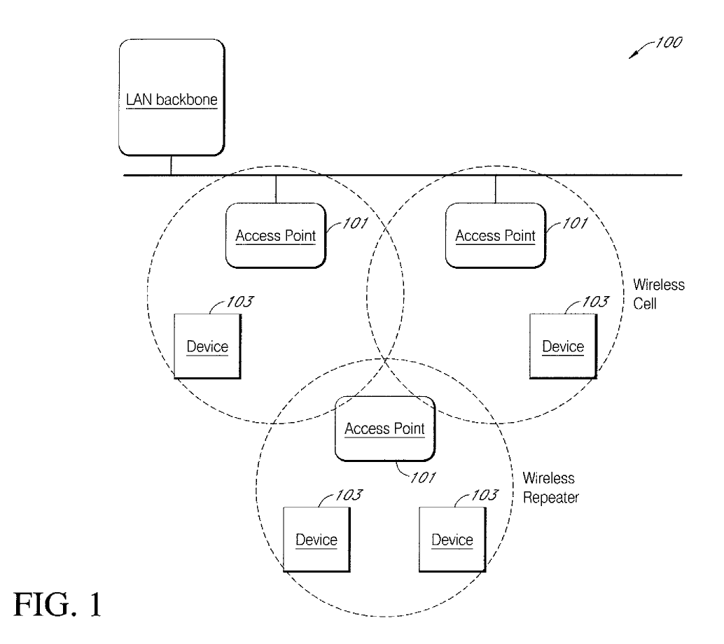

Exemplary implementations of the embodiments in a wireless local area network (WLAN) will now be described. FIG. 1 is a block diagram illustrating an example wireless local area network (WLAN) configuration 100 using an access point 101. The example WLAN configuration 100 includes one or more access points 101 and one or more wireless devices 103. The access point is a device that connects a wireless device 103 to the WLAN. In an access point based topology, the access points are connected to a wired or wireless backbone and routes the traffic through the wired (e.g., Ethernet or token ring) or wireless backbone. In a WLAN, the access point enables a wireless device 103 to communicate with other wired or wireless devices on the WLAN. In certain embodiments, the access point supports the IEEE 802.11 Protocol.

In certain embodiments, the access point 101 includes a receiver of wireless signals, and the wireless client device 103 includes a sender of the wireless signals. In other embodiments, the access point 101 includes a sender of wireless signals, and the wireless client device 103 includes a receiver of the wireless signals. In some of such embodiments, the wireless signals include audio content. In other embodiments, the wireless signals include video content. In yet other embodiment, the wireless signals include text content such as a publication. For example, the access point 101 can be a sink of video and/or audio data implemented, such as, in an HDTV set in a home wireless network environment which is a type of WLAN. The wireless device 103 can be a source of compressed or uncompressed video or audio. Examples of the wireless device 103 include a set-top box, a DVD player or recorder, a digital camera, a camcorder, and so forth. In some embodiments, the content can be protected content.

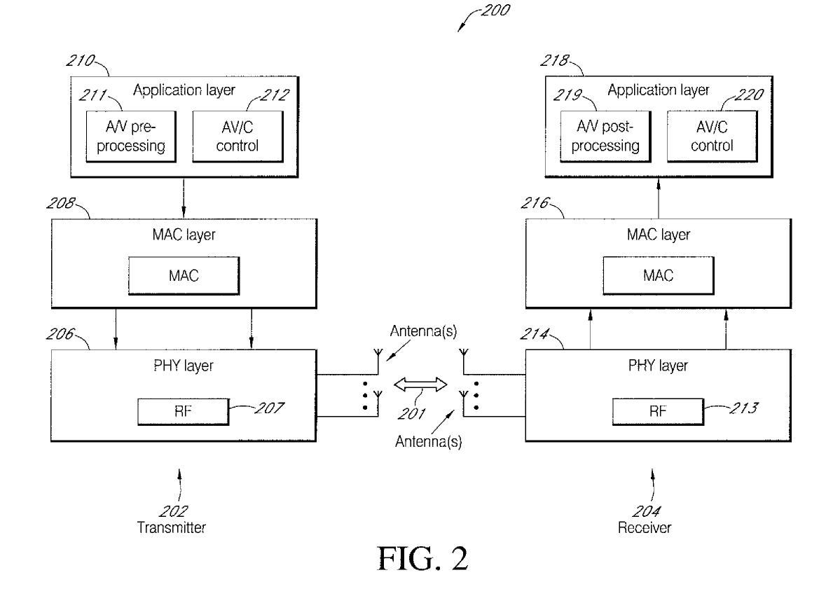

FIG. 2 illustrates a functional block diagram of an example wireless local area network (WLAN) system 200. The example WLAN system 200 includes a wireless transmitter 202 and wireless receiver 204. The transmitter 202 includes a physical (PHY) layer 206, a media access control (MAC) layer 208 and an application layer 210. Similarly, the receiver 204 includes a PHY layer 214, a MAC layer 216, and an application layer 218. The PHY layers provide wireless communication between the transmitter 202 and the receiver 204 via one or more antennas through a wireless medium 201.

The application layer 210 of the transmitter 202 includes a content pre-processing module 211 and a content control module 212. The content pre-processing module 211 can perform pre-processing of the content such as partitioning of video content. The content control module 212 provides a standard way to exchange content handling information such as A/V capability information, For example, before a connection begins, the content control module negotiates the A/V formats to be used, and when the need for the connection is completed, content control commands are used to stop the connection.

In the transmitter 202, the PHY layer 206 communicates with the MAC layer 208 and with a radio frequency (RF) module 207. In certain embodiments, the MAC layer 208 can include a packetization module (not shown). The PHY/MAC layers of the transmitter 202 add PHY and MAC headers to packets and transmit the packets to the receiver 204 over the wireless channel 201.

In the wireless receiver 204, the PHY/MAC layers 214, 216 process the received packets. The PHY layer 214 communicates with the MAC layer 216 and with the RF module 213. The application layer 218 of the receiver 204 includes a content post-processing module 219 and a content control module 220. The module 219 can perform an inverse processing method of the module 211, for example, to regenerate the uncompressed video, for example. In certain embodiments, the content control module 220 operates in a complementary way with the content control module 212 of the transmitter 202.

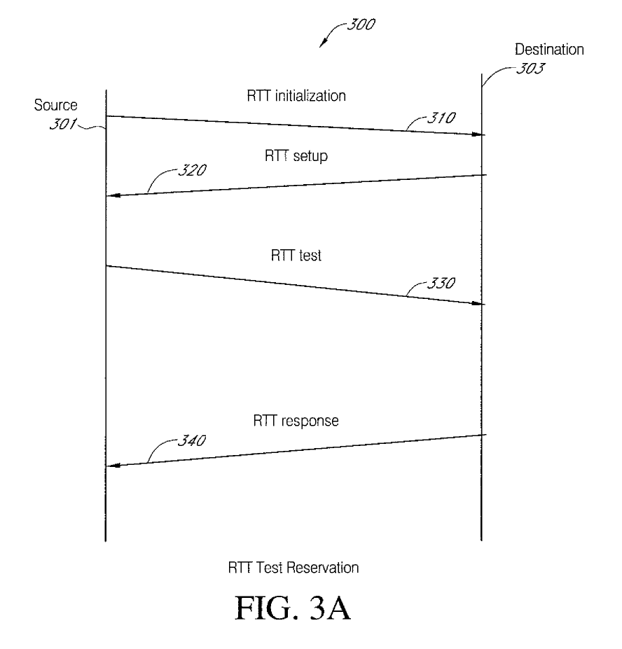

FIG. 3A is a timing diagram illustrating an example of a Round Trip Time (RTT) test procedure 300 between a Source 301 and a Destination 303. The procedure 300 includes an authentication procedure and the RTT test itself. In certain proximity protocols, the RTT test needs to be authenticated so that the system will not be compromised by malicious users. During the authentication procedure, authentication messages—a RTT initialization message 310 and a RTT setup message 320—are used to exchange authentication information between the Source 301 and the Destination 303. These messages can be transmitted through a random access period or through reservation. In wireless communication networks, e.g., WLAN, where multiple users are accessing the same medium, interferences from other devices in the network are commonplace; and, consequently, the actual RTT test involving transmission and reception of the RTT test data 330 and the RTT response data 340, respectively, may be delayed because of random access delays caused by the interferences from other devices. For example, if the authentication messages 310 and 320 are exchanged in the random access period, and the first transmission 330 failed because of interferences, second or third trials can be made. Because the RTT test is used to measure the round trip time, retransmissions introduce delays; and the devices in each other's proximity may be falsely refused. Certain embodiments of proximity control schemes designed to reduce interferences from other devices during RTT test are described below.

Some wireless protocols, e.g., IEEE 802.11, define and support reservation functions to avoid having stations transmit at the same time with the goal of reducing interferences and retransmissions in a wireless network, e.g., WLAN. In the IEEE 802.11 and 802.11e protocols, the defined reservation functions include Distributed Coordinated Function (DCF), Point Coordinated Function (PCF), and Hybrid Coordinated Function (HCF). Because these reservation functions are designed to avoid interferences from other devices during data transmission between two devices, they may be used as platforms for launching the RTT test for proximity control. Certain embodiments of RTT test supports for the 802.11/802.11e defined reservation functions, e.g., DCF, PCF, HCF, are described below.

FIG. 3B is a general flow diagram illustrating a process 350 for conducting a RTT test for proximity control using a reservation function in WLAN. Specific examples of systems and methods for conducting the RTT test are described in detail below. The process 350 starts at state 351, where a reservation function is prepared for RTT test between an RTT Source 301 and an RTT Destination 303, such as the ones shown in FIG. 3A. The RTT test preparation can be different for different reservation functions and will be described in detail below with respect to individual reservation functions. The process moves to state 353, where RTT test data is transmitted by the RTT Source during a contention-free period (CFP). The contention-free period refers to a time period in which transmissions by one or more devices in the WLAN other than the RTT Source and the RTT Destination are suppressed or disabled for reducing interferences. The process then moves to state 355, where RTT response data is transmitted by the RTT Destination also during a CFP. The process then moves to state 357, where the RTT response data is received by the RTT Source also during a CFP. The process then moves to state 359, where distance between the RTT Source and the RTT Destination is computed for the purpose of proximity control of copyrighted content.

### RTT Test Based on DCF

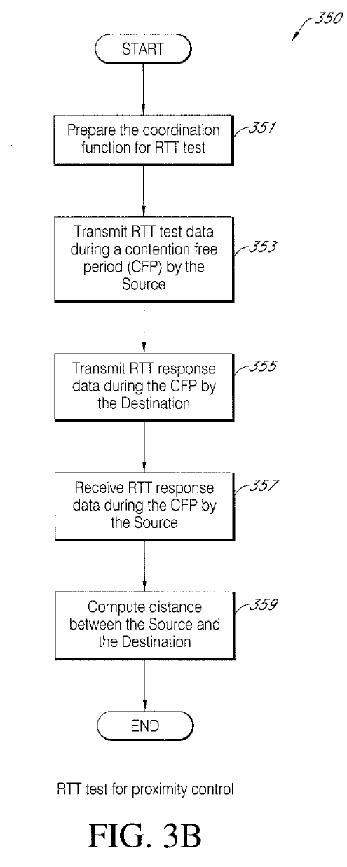

DCF is a reservation function that is fundamental to the IEEE 802.11 WLAN standard and is a form of a carrier sense multiple access with collision avoidance (CSMA/CA) protocol. CSMA/CA protocol requires stations in a wireless network to first sense the medium before transmitting. CSMA/CA, in turn, is a form of distributed media access control scheme for a distributed/ad hoc topology. Here, the distributed media access control scheme refers to techniques for accessing the media by individual devices without involving a central control device, e.g., a coordinator. FIG. 4 is a flow diagram illustrating an example process 400 for preparing the DCF function of IEEE 802.11 for a RTT test according to certain embodiments. The process 400 begins at state 410, where an RTT Source transmits a Request-To-Send (RTS) message. The process moves to state 420, where an RTT Destination, after receiving the RTS, transmits a Clear-To-Send (CTS) message. The process then moves to state 430, where after receiving either the RTS from the RTT Source or the CTS from the RTT Destination, one or more devices other than the RTT Source and the RTT Destination set a Network Allocation Vector (NAV) and stop transmissions. The NAV is used within a WLAN to prevent devices accessing the wireless medium and causing contention. In certain embodiments, the NAV is an indicator, maintained by each device, of time periods when transmission will not be initiated even though there is no traffic on the medium.

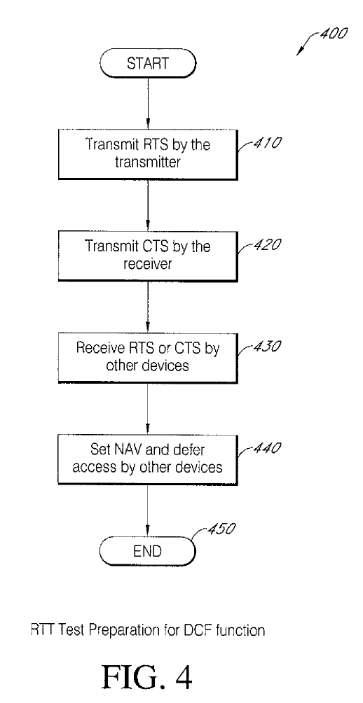

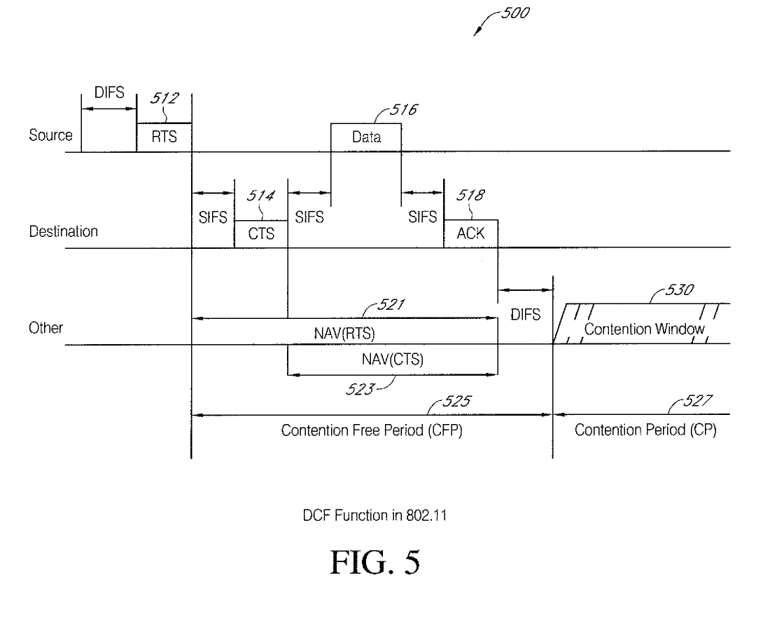

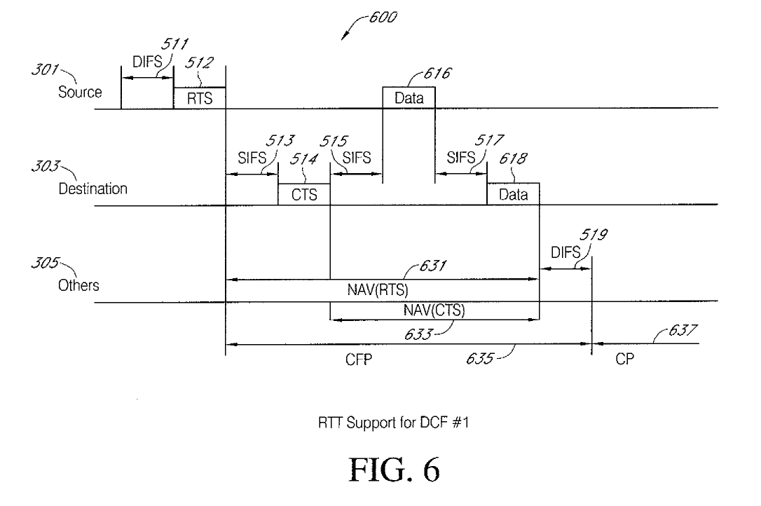

FIG. 5 is a timing diagram 500 illustrating an example of the existing distributed coordinated function (DCF) defined within the IEEE 802.11 and included for the purpose of illustrating certain embodiments of the RTT test support for the DCF function described below with reference to FIG. 6 and FIG. 7. The 802.11 standard makes it mandatory that all stations implement the DCF, a form of carrier sense multiple access with collision avoidance (CSMA/CA). Schemes to support RTT test using the DCF function are described below. In DCF, a data communication 516 from a Source to a Destination takes place during a contention free period (CFP) 525. The CFP condition is created when one or more devices other than the Source and the Destination receive either Request-To-Send (RTS) 512 transmitted by the Source or Clear-To-Send (CTS) 514 transmitted by the Destination and maintain a NAY 521, 523 and stop contending for data transmissions. The CFP expires after the Destination transmits an acknowledgement (ACK) 518, and a contention period (CP) 527 and a corresponding contention window 530 follows.

FIG. 6 is a timing diagram 500 illustrating an example of RTT test support for the DCF function according to certain embodiments. To support a RTT test, modifications need to be made to existing DCF functions such as the one illustrated in FIG. 5. For example, in IEEE 802.11, in RTS and CTS frame formats, there can be two fields: type (control) 2 bits and subtype 4 bits. The fields are combined to indicate which type of control these RTS and CTS are for. To support RTT test, these bits are used to indicate that these RTS and CTS are for RTT control. In certain embodiments, a duration field of the RTS or CTS is also set accordingly for RTT control, so that the corresponding NAV is set specially for RTT test. In certain embodiments, the duration field includes a suggested time duration for the NAV. The reservation of DCF for RTT test is used for both directions of transmissions. Returning to FIG. 6, the RTT Source 301 transmits the RTS 512 after the wireless medium has been idle for a first DCF inter-frame space (DIFS) period 511. After receiving the RTS 512, the RTT Destination 303 transmits the CTS 514 following a first short inter-frame space (SIFS) 513. After receiving the CTS, the RTT Source transmits a RTT test data 616 following a second SIFS 515. After receiving the RTT test data 616, the RTT Destination transmits a RTT response data 618 following a third SIFS 517.

With regards to the other devices 305 in the WLAN, they can maintain the NAV and stop contending channels for data transmissions in one of two ways. The first way is where the other devices maintain a RTS-triggered NAV 631 after receiving the RTS 512 transmitted by the RTT Source. The maintenance of the RTS-triggered NAV 631 can mark the beginning of a contention free period (CFP) 635. The second way is where the other devices maintain a CTS-triggered NAV 633 after receiving the CTS message 514 transmitted by the RTT Destination. In the example embodiment shown, the RTS-triggered NAV 631 is set as 3*SIFS+CTS+2*DATA, while the CTS-triggered NAV 633 is set for a time period as 2*SIFS+2*DATA. After the period indicated by the NAV is past, the defer access period 635 finally expires following a second DIFS period 519. After the expiration of the CFP 635, a contention period (CP) 637 returns during which all devices in the WLAN are allowed to contend a channel to initiate transmissions.

FIG. 7 is a timing diagram 700 illustrating another example of RTT test support for the DCF function according to certain embodiments. The RTT Source 301 transmits the RTS 512 after the wireless medium has been idle for a first DCF inter-frame space (DIFS) period 511. After receiving the RTS message 512, the RTT Destination 302 transmits the CTS 514 following a first short inter-frame space (SIFS) 513. After receiving the CTS, the RTS Source transmits a RTT test data 716 following a second SIFS 515. After receiving the RTT test data 716, the RTT Destination transmits an Acknowledgement (ACK) 518 following a third SIFS 517. Immediately following the ACK 518, the RTT Destination transmits a RTT response data 721. After receiving the ACK message and the RTT response data, the RTT Source transmits its own ACK message 725 following a fourth SIFS 723. In the example embodiment shown, the RTS-triggered NAV 731 is set as 4*SIFS+CTS+2*DATA+2*ACK, while the CTS-triggered NAV 733 is set as 3*SIFS+2*DATA+2*ACK.

### RTT Test Based on PCF

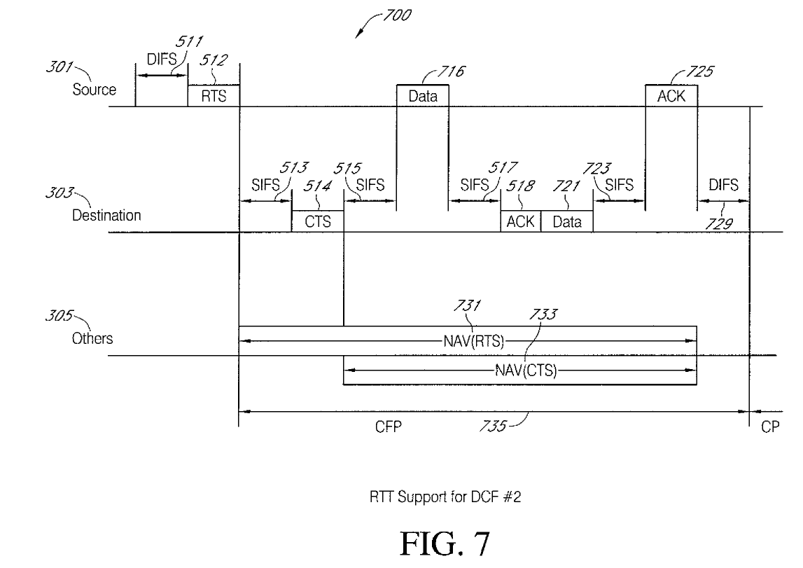

FIG. 8 is a flow diagram illustrating an example process 800 for preparing the PCF function of IEEE 802.11 for RTT test according to certain embodiments. The process 800 begins at state 810, where an access point (AP) prepares a poll packet. The poll packet includes a MAC address for the polled station. In certain embodiments, the polled packet includes a MAC address for the RTT Source. In certain other embodiments, the poll packet includes MAC addresses for both the RTT Source and the RTT Destination. The process moves to state 820, where the AP transmits the poll packet. The process then moves to state 830, where the poll packet is received by the polled station. The process 800 completes at an end state.

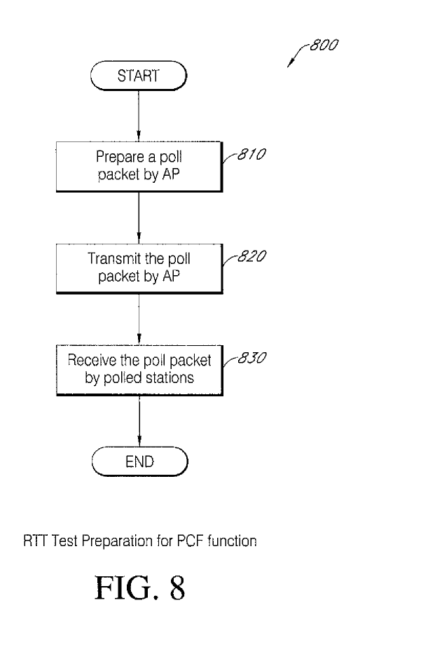

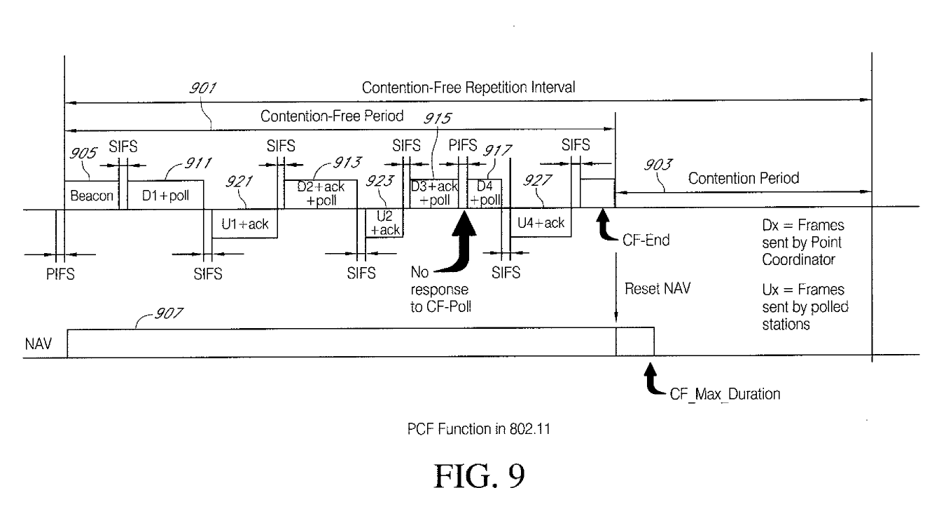

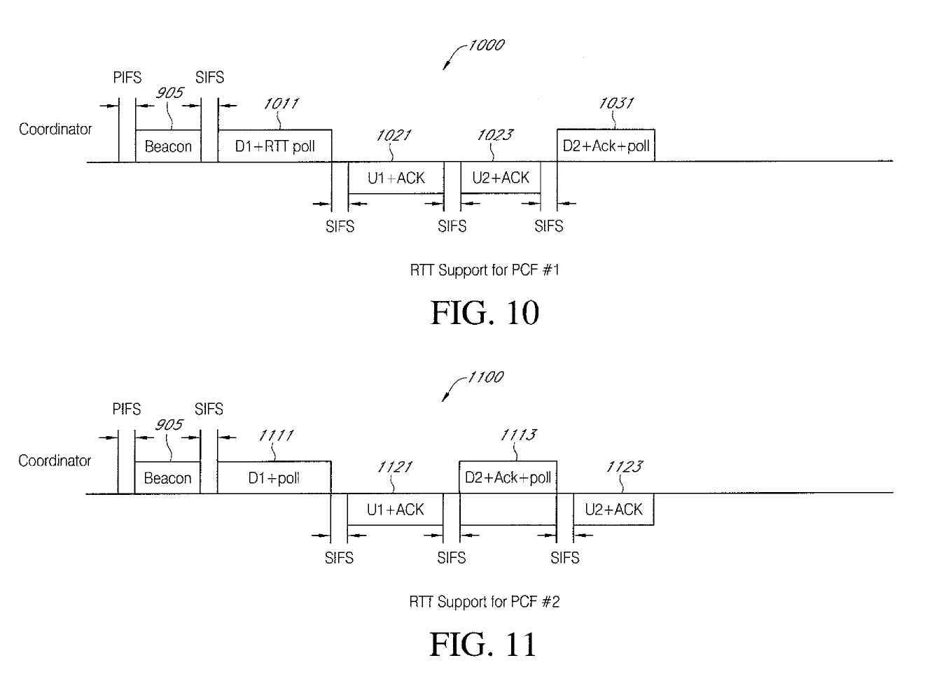

FIG. 9 is a timing diagram illustrating an example of the existing point coordinated function (PCF) defined within IEEE 802.11 and included for the purpose of illustrating certain embodiments of the RTT test support for the PCF function described below with reference to FIG. 10 and FIG. 11. The original 802.11 protocol defines another reservation function called the Point Coordinated Function (PCF). The PCF is available only in “infrastructure” mode, where stations are connected to the network through an Access Point (AP). In the example, the AP is the coordinator in the WLAN. Unlike the DCF, which is mandatory in IEEE 802.11, the PCF mode is optional. Also unlike the DCF, which is a CSMS/CA-based reservation function based on a distributed media access control scheme, the PCF is a centralized media access control scheme involving a central control device, e.g. an access point (AP). In particular, the PCF is based on a polling-based centralized media access scheme in which the central control device, e.g., AP, polls devices to initiate a contention-free data communication between the polled devices. In the PCF mode, the AP sends beacon frames 905 at regular intervals. Between these beacon frames, the PCF defines two periods: the Contention Free Period (CFP) 901 and the Contention Period (CP) 903. The NAV 807 is maintained throughout CFP 901, suppressing data transmissions. In CP 903, the DCF is simply used. In CFP 901, the AP sends Contention Free-Poll (CF-Poll) packets 911, 913, 915, and 917 to each station, one at a time, to give them the right to send data packets 921, 923, and 927. In the example given, no response to the third CF-Poll packet 925 was received.

FIG. 10 is a timing diagram 1000 illustrating an example of RTT test support for the PCF function according to certain embodiments. In the example, the AP, e.g., the coordinator, after transmitting the beacon 905, polls a pair of stations, e.g., Device A and Device B, at one time by transmitting a CF-Poll packet 1011. In the first CF-Poll packet 1011, MAC addresses for the both polled stations are included. In response to the CF-Poll packet 1011, one station transmits a first data packet 1021. The first data packet 1021 includes RTT test data and ACK. In response to the first data packet 1021, the other station transmits a second data packet 1023. The second data packet includes RTT response data and ACK. After the AP receives the ACK from the RTT Destination, it can poll another pair of stations by sending another CF-Poll packet 1031.

FIG. 11 is a timing diagram 1100 illustrating another example of RTT test support for the PCF function according to certain embodiments In the example, MAC addresses for a pair of stations being polled are put into different CF polling packets 1111 and 1113. However, in some embodiments, the MAC addresses of this pair of stations can be put into the polling queue adjacent to each other. In certain embodiments, the stations are polled one after another to reduce any access delays. In the example, the CF polling packets include a first CF polling packet 1111 and a second CF polling packet. In response to the first CF polling packet 1111, one station acting as the RTT Source transmits a first data packet 1121. The first data packet 1121 includes RTT test data and ACK. In response to the second CF polling packet 1113, the other station acting as the RTT Destination transmits a second data packet 1123. The second data packet includes RTT response data and ACK. The total delay for the RTT test in this example, however, can be longer than that in the example given in FIG. 10. Time-out is used to detect whether the packet is lost or not.

### RTT Test Based on HCF

IEEE 802.11e is an approved amendment to the IEEE 802.11 standard that defines a set of Quality of Service (QoS) enhancements for WLAN applications through modifications to the MAC layer. The 802.11e standard includes a new reservation function, the Hybrid Coordinated Function (HCF), that represents an enhancement over a polling-based reservation protocol such as the PCF. For the AP and stations which have the HCF and the QoS support, the AP can allocate Transmission Opportunity (TXOP) period to support data sequence transmissions between the AP and the station. The supported sequences are specified in IEEE 802.11e. However, for the RTT test, transmission opportunities for two devices need to be reserved through the AP in certain embodiments. In order to support RTT test between device A and device B, a bidirectional RTT TXOP can be defined and used. The RTT TXOP can include a RTT test data frame (from device A) and a subsequent RTT response data (from device B). Within the HCF framework, a flexible period of time can also be reserved to accommodate retransmissions, for example, 7 ms or less in certain embodiments.

Various advantages of performing RTT test during one of the 802.11 defined functions—DCF, PCF, and HCF—described above will be apparent to the one skilled in the art. For example, the defined functions, having been designed to reduce data collisions and interferences in a wireless network, provide appropriate platforms to launch the RTT test for proximity control in WLAN. In particular, the RTT test can be implemented in the DCF and the PCF with only minor modifications to the existing defined features. In contrast, existing RTT schemes cannot support accurate RTT in a wireless network without incurring long random access delays.

Although the systems and methods for RTT test supports for proximity control are described above with regards to specific IEEE 802.11/802.11e functions, it will be apparent to the one skilled in the art that the systems and methods can be applied to other wireless protocols, such as Bluetooth.

### CONCLUSION

While the above detailed description has shown, described, and pointed out the fundamental novel features of the invention as applied to various embodiments, it will be understood that various omissions and substitutions and changes in the form and details of the system illustrated may be made by those skilled in the art, without departing from the intent of the invention.

What is claimed is:

1. A method of providing a proximity control between devices in a wireless network, the method comprising:
transmitting a test message for a round trip time (RTT) test to a second device by a first device via a modified reservation function, wherein the modified reservation function is based on a distributed media access control scheme;
receiving a response message for the RTT test from the second device via the modified reservation function; and
computing a distance between the first device and the second device based at least partly on a round trip time delay between the test message and the response message.

2. The method of claim 1 wherein the wireless network is configured for transmitting audio and/or video (A/V) data.

3. The method of claim 1, wherein the distributed media access control scheme includes a carrier sense multiple access with collision avoidance (CSMA/CA) protocol.

4. The method of claim 1, wherein the modified reservation function is modified from a standard reservation function prior to transmitting the RTT test data.

5. The method of claim 4, wherein the standard reservation function is a Distributed Coordinated Function (DCF).

6. The method of claim 1, wherein the modified reservation function is a modified Distributed Coordinated Function (DCF) and comprises one or more type bits in a Request To Send (RTS) message or a Clear To Send (CTS) message for indicating that the RTS or the CTS is being transmitted for the RTT test.

7. The method of claim 1, wherein the modified reservation function is a modified DCF function and comprises a duration field in a Request To Send (RTS) message or a Clear To Send (CTS) message for indicating to a third device in the wireless network to set its Network Allocation Vector (NAV) during the RTT test, wherein the duration field includes a suggested time duration for the NAV.

8. A system for providing a proximity control between devices in a wireless network, the system comprising:
a transmitter configured to transmit a test message for a Round Trip Time (RTT) test to a second device by a first device via a modified reservation function, wherein the modified reservation function is modified from a standard reservation function based on a distributed media access control scheme to utilize the RTT test;
a receiver configured to receive a response message for the RTT test from the second device via the modified reservation function; and
a processor configured to compute a distance between the first device and the second device based at least partly on a round trip time delay between the test message and the response message.

9. The system of claim 8, wherein the standard reservation function is a Distributed Coordinated Function (DCF).

10. The system of claim 9, wherein a Request To Send (RTS) message or a Clear To Send (CTS) message for the modified DCF function includes:
one or more type bits for indicating that the RTS or the CTS is being transmitted for the RTT test; and
a duration field for indicating to a third device in the wireless network to set its Network Allocation Vector (NAV) during the RTT test, wherein the duration field includes a time duration which has the length at least equal to the scheduled transmissions of the RTT test and response commands for the NAV.

11. A method of providing a proximity control between devices in a wireless network, the method comprising:
transmitting a test message for a Round Trip Time (RTT) test to a second device by a first device via a modified reservation function, wherein the modified reservation function is based on a polling-based centralized media access control scheme;
receiving a response message for the RTT test from the second device via the modified reservation function; and
computing a distance between the first device and the second device based at least partly on a round trip time delay between the test message and the response message.

12. The method of claim 11, wherein the wireless network is configured for transmitting uncompressed video data.

13. The method of claim 11, wherein the modified reservation function is modified from a standard reservation function prior to transmitting the RTT test data.

14. The method of claim 13, wherein the standard reservation function is a Point Coordinated Function (PCF).

15. The method of claim 11, wherein the modified reservation function is a modified Point Coordinated Function (PCF) and comprises media access control layer (MAC) addresses for both the first device and the second device in a polling packet configured to be transmitted by an access point (AP).

16. The method of claim 14, wherein the modified reservation function is a modified PCF function and comprises a first MAC address for the first device in a first polling packet and a second MAC address for the second device in a second polling packet.

17. The method of claim 16, wherein the first MAC address and the second MAC address are put into a polling queue adjacent to each other when the RTT test is initiated.

18. The method of claim 13, wherein the standard reservation function is a Hybrid Coordinated Function (HCF).

19. The method of claim 11, wherein the modified reservation function is a modified Hybrid Coordinated Function (HCF) and comprises a bidirectional RTT transmission opportunity (TXOP), wherein the TXOP includes a data frame for transmitting RTT test data by a RTT source device and a TXOP includes a data frame for transmitting RTT response data from a RTT destination.

20. A system for providing a proximity control between devices in a wireless network for transmitting uncompressed video data, the system comprising:
a transmitter configured to transmit a test message for a Round Trip Time (RTT) test to a second device by a first device via a modified reservation function, wherein the modified reservation function is modified from a standard reservation function based on a centralized media access control scheme to utilize the RTT test;
a receiver configured to receive a response message for the RTT test from the second device via the modified reservation function; and
a processor configured to compute a distance between the first device and the second device based at least partly on a round trip time delay between the test message and the response message.

21. The system of claim 20, wherein the standard reservation function is a Point Coordinated Function (PCF).

22. The system of claim 21, wherein the modified PCF function comprises a polling packet configured to be transmitted by an access point (AP), wherein the polling packet includes access control layer (MAC) addresses for both the first device and the second device.

23. The system of claim 21, wherein the modified PCF function comprises a polling packet configured to be transmitted by an access point (AP), wherein the polling packet includes a first access media control layer (MAC) address for a first device and a second MAC address for the second device.

24. The system of claim 20, wherein the standard reservation function is a Hybrid Coordinated Function (HCF), wherein the modified HCF function comprises a bidirectional RTT transmission opportunity (TXOP), wherein the TXOP includes a data frame for transmitting RTT test data by a RTT source device and a data frame for transmitting RTT response data by a RTT destination device.

25. A computer-usable medium in a system for providing a proximity control between devices in a wireless network having computer readable code comprising instructions for:
modifying a reservation function so as to support a Round (RTT) test between a first device and a second device in a wireless network; and
computing a distance between the first device and the second device based at least partly on a round trip time delay between a RTT test message and a RTT response message transmitted and received via the modified reservation function.
